(19) United States
(12) Patent Application Publication
(10) Pub. No.: US 2021/0270527 A1
(43) Pub. Date: Sep. 2, 2021

(54) Apparatus for Drying Spent Ion-Exchange Resins

(71) Applicants: JOINT STOCK COMPANY "ROSENERGOATOM", Moscow (RU); SCIENCE AND INNOVATIONS - NUCLEAR INDUSTRY SCIENCE DEVELOPMENT, PRIVATE ENTERPRISE, Moscow (RU)

(72) Inventors: Denis Evgen'evich BELOKON', g. Novouralsk (RU); Aleksandr Valer'evich KOLCHANOV, g. Ekaterinburg (RU); Dmitriy Arkhipovich KUKIEV, g. Ekaterinburg (RU)

(21) Appl. No.: 17/257,279

(22) PCT Filed: Dec. 23, 2019
(86) PCT No.: PCT/RU2019/001053

§ 371 Date: Dec. 30, 2020

(30) Foreign Application Priority Data
Apr. 19, 2019 (RU) 2019112024

(51) Int. Cl. F26B 9/08

(52) U.S. Cl. CPC F26B 9/085

(57) ABSTRACT

Apparatus for drying Spent Ion-Exchange Resins (SIER), which can intensify the SIER drying process, reduce power consumption, and accelerate discharge of SIER when the drying process is completed. The apparatus comprises a sealed cylindrical body, and a blow-down choke installed in an upper part of the sealed cylindrical body and a nozzle to feed the spent ion-exchange resins is installed inside the body, and a nozzle to retrieve dried ion-exchange resins is installed in its bottom part and equipped with a locking device. An external heater is provided for the body, and a drive shaft that is installed in alignment inside the body, capable of rotation, and equipped with a stirrer. A lower part of the drive shaft with lower screw winding is installed in alignment inside the nozzle to retrieve dried ion-exchange resins. The nozzle to retrieve dried ion-exchange resins is equipped with a water draining device.

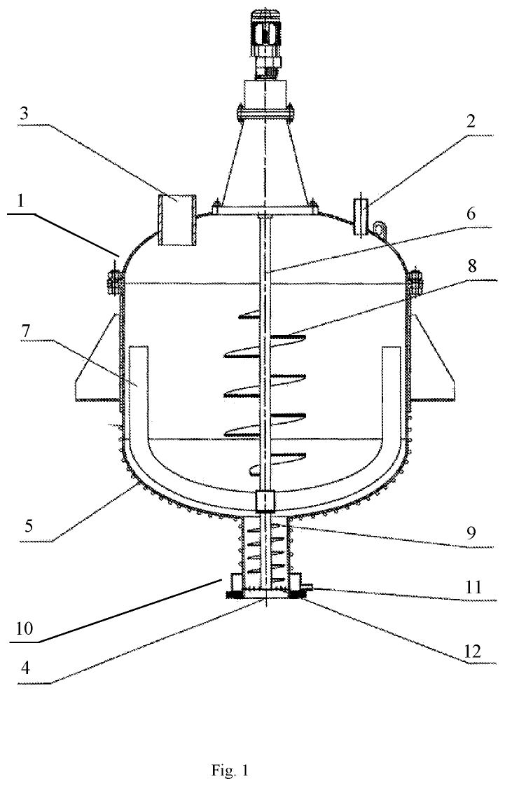

This invention is referred to atomic energy, in particular, to drying of Spent Ion-Exchange Resins (SIER) and can be used at NPPs or special radioactive wastes processing plants.

Ion-exchange resins are widely used at NPPs to ensure water chemistry in primary and secondary circuits, fine filtering of evaporation plant condensate and in other auxiliary water systems, as well as during NPP decommissioning. Considerable volume of SIER is accumulated during operation, so these resins are required to be processed for further storage. Long-term and safe storage of SIER is possible in the sealed protective casks, where SIER's residual moisture content is not more than 5% by weight. This limit is stipulated by possible radiolysis of residual moisture during storage/disposal of a sealed protective cask.

A plant for thermal processing of radioactive ion-exchange resins is well-known now (Patent of the RF for useful model No. 121396), it contains thermal reactor that is equipped with loading and discharging units and the heater. This plant also contains water vapors condenser, connected to thermal reactor by main pipe, condensate receiver, connected to water vapors condenser via main pipe, as well as vacuum pump which inlet is connected to condensate receiver and its outlet is connected to air exhaust main pipe.

Low energy efficiency of the process is one of the disadvantages related to the above described SIER drying method.

The spent ion-exchange resins drying plant (Patent of the RF No 161811), comprising the cylindrical body, in upper part of which the vapor and gas exhaust choke is installed and the nozzle to feed spent ion-exchange resins inside the body and the nozzle to retrieve dried ion-exchange resins, equipped with the locking device is installed in bottom part of the body is the most similar technical solution that is taken as a prototype. The cylindrical body is also equipped with the external heater for the body, that is installed in alignment inside the body and that can be rotated by drive shaft, equipped with the stirrer.

Disadvantage of the closest analogue is referred to low specific capacity of the process, as well as too long period of drying and it's resulted in increased power consumption.

Object of the claimed invention is to intensify SIER drying process and to reduce power consumption, and to accelerate discharge of SIER when drying process is completed.

Technical result that can be achieved by the claimed invention is to reduce period and power consumption for SIER drying process as well as to accelerate discharge of SIER when drying process is completed.

The indicated technical result can be achieved due to installation of the blow-down choke and the nozzle to feed the spent ion-exchange resins inside the body in upper part of the sealed cylindrical body of the spent ion-exchange resins drying plant, as well as the nozzle to retrieve dried ion-exchange resins is installed in its bottom part, and this nozzle is equipped with the locking device, the external heater for the body and the drive shaft that is installed in alignment inside the body including possibility of its rotation, and it's equipped with the stirrer, it's proposed to make the stirrer as an anchor mixer that is rigidly fixed on the drive shaft, the mixer blades shall follow the shape of internal surface of bottom and side part of the body and located on the drive shaft upper and lower the place where the anchor mixer is fixed including upper and lower one-way screw windings, by this lower part of the drive shaft with lower screw winding shall be installed in alignment inside the nozzle to retrieve dried ion-exchange resins and the nozzle to retrieve dried ion-exchange resins shall be equipped with the water draining device.

Height of blades of the anchor mixer and the upper screw winding located on the drive shaft mainly shall be more than the height of heating area of the external heater for the body.

The water draining device can be made in the form of cylindrical water tank that is coaxially installed at lower edge of the nozzle and aimed to retrieve drained ion-exchange resins, including special choke to drain water, and on perimeter of lower cylindrical part of the nozzle to retrieve drained ion-exchange resins, the holes are made to connect inner cavity of the nozzle with the water tank cavity.

Scheme of the spent ion-exchange resins drying plant in one of the variants is given on the drawing.

The spent ion-exchange resins drying plant shall contain the sealed cylindrical body 1, in upper part of which the blow-off choke 2 is installed and the nozzle 3 to feed spent ion-exchange resins inside the body 1 is installed, as well as in its bottom part, the nozzle 4 is installed to retrieve spent ion-exchange resins and it is equipped with the locking device (it's not shown on the drawing) and the water draining device. The sealed cylindrical body 1 is equipped by the external heater 5.

The drive shaft 6 that is equipped by a stirrer is installed in alignment in the sealed cylindrical body 1 with a possibility of its rotation. The stirrer as an anchor mixer 7 that is rigidly fixed on the drive shaft 6, the mixer blades shall follow the shape of internal surface of bottom and side part of the sealed cylindrical body 1 and located on the drive shaft 6 upper and lower the place where the anchor mixer 7 is fixed including upper 8 and lower 9 one-way screw windings. Lower part of the drive shaft 6 with the lower screw winding 9 is place in alignment inside the nozzle 4 to retrieve dried ion-exchange resins.

Model of the spent ion-exchange resins drying plant, in which blades of the anchor mixer 7 and the upper screw winding 9 located on the drive shaft 6 are made at the height that is more than heating area of the external heater 5, as well as the water draining device is made as cylindrical water tank 10 installed outside coaxially on lower end of the nozzle 4 to retrieve dried ion-exchange resins, including the choke 11 to drain water, and on perimeter of the lower cylindrical part of the nozzle 4 to retrieve drained ion-exchange resins, the holes 12 shall be made to connect inner cavity of the nozzle 4 with the water tank cavity 10 is shown on the drawing.

The spent ion-exchange resins drying plant is operated in the following way. The nozzle 4 to retrieve dried ion-exchange resins shall be closed by the locking device. De-watered SIER with mass ratio “Solid phase:Liquid” (S:L) from 1:1 to 1:3 can be partly loaded into the sealed cylindrical body 1 through the nozzle 1 to feed spent ion-exchange resins. Excessive liquid shall be drained by gravity from the sealed cylindrical body 1 through the holes 12, made on lower cylindrical part of the nozzle 4 to retrieve dried ion-exchange resins, into the cylindrical water tank 10 and then it shall be drained via the choke 11 into the radioactive drain system. When the sealed cylindrical body 1 is filled, feed of SIER shall be stopped and vacuum shall be created inside the sealed cylindrical body 1 through the blow-off choke 2. The external heater (electric or steam) 5 shall be activated and rotation of the drive shaft 6 where the anchor mixer 7 and one-way upper 8 and lower 9 screw windings are rigidly installed, shall be initiated. By this one-way upper screw winding 8 and lower screw winding 9 along with the drive shaft 6 are rotated in such direction in which SIER are pushed up from the nozzle 4 to retrieve dried ion-exchange resins and lower part of the sealed cylindrical body 1, shall initiate movement inside the body 1 and additionally are intensively stirred by the anchor mixer blades. Temperature of SIER by means of the external heater 5 during drying process shall be maintained not more than 90° C. aimed to avoid thermal decomposition of SIER. When SIER drying process is completed, the external heater 5 shall be deactivated and rotation of the drive shaft 6 shall be stopped. SIER shall be cooled up to the temperature, not exceeding 50° C. before discharge from the plant.

Sealed protective cask (container) shall be installed under the nozzle 4 to retrieve dried ion-exchange resins to discharge the dried SIER. The locking device installed in lower part of the nozzle 4 to retrieve dried ion-exchange resins shall be opened and the dried SIER shall be discharged into the cask. Reverse rotation of the drive shaft 6 shall be activated to improve and accelerate the process to discharge the dried SIER. By this one-way upper screw winding 8 and lower screw winding 9 along with the drive shaft 6 are rotated in such direction in which SIER are pushed down from the sealed cylindrical body 1 and the nozzle 4 to retrieve dried ion-exchange resins and they shall be discharged into the sealed protective cask.

The claimed invention shall ensure reduction of power consumption, the process stimulation and considerable reduction of drying period due to effective mixing of SIER during drying process, as well as acceleration of SIER discharge when drying is completed.

What is claimed is:

1. An apparatus for drying spent ion-exchange resins comprising a sealed cylindrical body, in upper part of which blow-off choke is installed and a nozzle to feed spent ion-exchange resins inside the body is installed, as well as in its bottom part, the nozzle is installed to retrieve spent ion-exchange resins and it is equipped with the locking device, the external heater for the body and the drive shaft that is installed in alignment inside the body including possibility of its rotation, and it's equipped with the stirrer, it's proposed to make the stirrer as an anchor mixer that is rigidly fixed on the drive shaft, the mixer blades shall follow the shape of internal surface of bottom and side part of the body and located on the drive shaft upper and lower the place where the anchor mixer is fixed including upper and lower one-way screw windings, by this, lower part of the drive shaft with lower screw winding shall be installed in alignment inside the nozzle to retrieve the dried ion-exchange resins and the nozzle to retrieve the dried ion-exchange resins shall be equipped with the water draining device.

2. The apparatus for drying spent ion-exchange resins according to claim 1, wherein blades of the anchor mixer and upper screw winding, installed on the drive shaft shall be more than the height of heating area in the external heater for the body.

3. The apparatus for drying spent ion-exchange resins according to claim 1, wherein the water draining device is made in the form of cylindrical water tank that is coaxially installed at the lower end of the nozzle and aimed to retrieve drained ion-exchange resins, including special choke to drain water, and on perimeter of the lower cylindrical part of the nozzle to retrieve drained ion-exchange resins, the holes are made to connect inner cavity of the nozzle with the water tank cavity.
